(19) United States
(12) Patent Application Publication
(10) Pub. No.: US 2015/0252598 A1
(43) Pub. Date: Sep. 10, 2015

(54) TWO POINT LOCK FOR BI-FOLD WINDOWS AND DOORS

(71) Applicants: Edward Norton Sieglaar, Auckland (NZ); Cristina Roman, Auckland (NZ)

(72) Inventors: Edward Norton Sieglaar, Auckland (NZ); Cristina Roman, Auckland (NZ)

(73) Assignee: Schlage Lock Company LLC, Indianapolis, IN (US)

(21) Appl. No.: 14/387,077

(22) PCT Filed: Mar. 21, 2012
(86) PCT No.: PCT/US12/29949

§ 371 Date: May 18, 2015

(51) Int. Cl. E05C 1/08; E05B 61/00; E05C 3/12; E05C 1/00; E05C 1/10

(52) U.S. Cl. CPC E05C 1/08; E05C 1/002; E05C 1/10; E05C 3/12; E05C 3/124; E05B 61/00

(57) ABSTRACT

A two point lock for securing bi-folding windows and doors in which upper and lower shoot bolt arms move in opposite directions from a central lock body upon rotation of a handle. When the arms are in their mutually extended positions, a sliding detent locking member engages the upper shoot bolt arm to secure the window or door in the closed position. The central lock body includes a rotating driver for the shoot bolt arms that is supported at both ends and is maintained in two different positions by interaction with the curved contact faces of a set of biasing pads.

### TECHNICAL FIELD

The present invention relates to locks which use shoot bolts to secure a window or door in its closed position, and more particularly, but not exclusively, to a two point lock for use in bi-fold windows and doors.

### BACKGROUND

A bi-fold door is a type of sliding door that has multiple hinged sections that fold together as the door is opened, and thus it is conventionally locked by way of vertical shoot bolts that project from the door into the surrounding frame so as to anchor the door at its top and bottom. The shoot bolts are typically connected by rods to shoot bolt arms of a central lock, and the shoot bolt arms are operatively coupled to a rotating driver so as to be moved linearly in opposite directions as the driver rotates. The rotating driver is typically provided as a follower to the spindle of a lever style handle, and thus when the handle is in one orientation (e.g. horizontal) the shoot bolts are fully retracted and when the handle is in another orientation (e.g. vertical) the shoot bolts are fully extended.

In the bi-fold door lock marketed by Assa Abloy Australia Pty Limited (Sherwood QLD) as the TWIN BOLT LOCK, the spindle follower is rotatably mounted in one side of the lock casing and a tensioning disk is mounted at the other end of the spindle follower. The tensioning disk has four flattened sections that interact with the flat interior side walls of the lock casing to bias the follower towards two different home positions corresponding to the shoot bolts being either fully extended or fully retracted. The rotation of the spindle follower is converted to opposite linear motion of the shoot bolt arms by way of a planetary gear system, i.e. the spindle follower is the central gear and each shoot bolt arm is pivotably linked to a respective satellite gear. And for applications requiring additional security, deadlocking is provided by using a key cylinder to press a locking plate into engagement with the follower, thereby preventing the follower from rotating.

While a bi-fold style lock can generally be employed in other types of doors, such as in the secondary door of a set of French doors, there are unique challenges to meeting the demands of bi-fold doors. This is because in most bi-fold doors applications, it is desirable to have the handle mounted on only one side of the door (the interior side) in order to leave the other side (the exterior side) unobstructed. This allows the sections to lay flat against each other when the door is fully opened, but it also results in the exterior end of the spindle being unsupported. Thus, as one pulls on the lever handle to open a bi-fold door, there can be a tendency for the spindle to move or shift within the lock.

As present bi-fold lock designs suffer from a variety of drawbacks, limitations, disadvantages and problems, there is need for improvement in the art.

### SUMMARY

According to one aspect, a unique bi-fold lock is provided in which the shoot bolts can be locked in their extended position in more secure manner so as to be resistant to being overcome by force. According to another aspect, a unique bi-fold lock is provided in which the handle in more securely maintained in its two different rest positions. Accordingly to another aspect, a unique bi-fold lock is provided in which the shoot bolt driving mechanism is simple in design and construction. According to another aspect, a unique bi-fold lock is provided in which the shoot bolt driving mechanism can better tolerate or prevent shifting of the spindle. Further embodiments, forms, features, aspects, benefits, and advantages of the present application shall become apparent from the description and figures provided herewith.

### BRIEF DESCRIPTION OF THE FIGURES

Features of the invention will be better understood from the following detailed description when considered in reference to the accompanying drawings, in which:

FIG. 1 is an exploded view of a two point lock according to one embodiment installed in a conventional bi-fold door.

FIG. 2 is an exploded view of the lock of FIG. 1.

FIG. 3 is an elevational view in partial section showing the FIG. 1 lock in an unlocked configuration with the shoot bolt arms retracted.

FIG. 4 is an elevational view in partial section showing the FIG. 1 lock in a locked configuration with the shoot bolt arms extended.

FIG. 5 is an perspective view of one of the biasing pads used in the FIG. 1 lock.

FIG. 6 is an elevational view of the biasing pad of FIG. 5.

### DETAILED DESCRIPTION OF THE ILLUSTRATIVE EMBODIMENT

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments and any further applications of the principles of the invention as described herein are contemplated as would normally occur to one skilled in the art to which the invention relates.

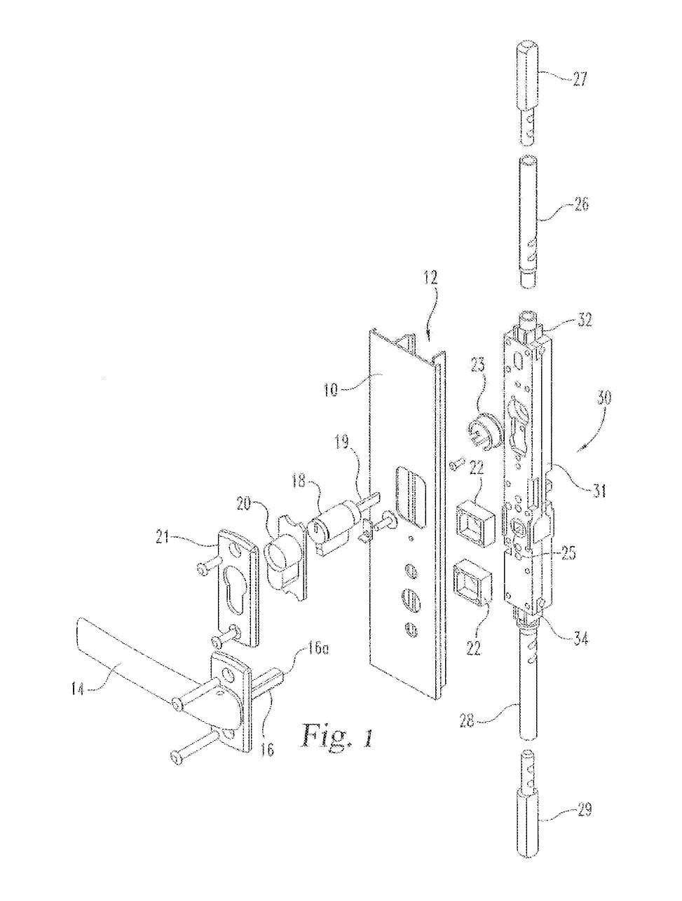

With reference to the Figures, two point lock 30 is designed to be embedded within the stile 10 of a conventional bi-fold window or door. The lock 30 is mounted within the stile 10 in a manner that is generally similar to known locks, and thus only a representative section of the stile 10 is shown in FIG. 1.

The central lock 30 is positioned in the hollow cavity 12 that extends the length of stile 10 with appropriately sized packers 22 clipped to casing 31 to position the lock at the appropriate depth within the cavity 12. Upper and lower connecting rods 26, 28 are screwed into the ends of the corresponding shoot bolts bolt arms 32 and 34 and, after the rods are cut to the appropriate length, D shaped tips 27, 29 are crimped in the ends of the connecting rods 26, 28.

The spindle 16 of the lever style handle 14 extends through the stile 10 and through the correspondingly shaped opening 25 in lock 30. The end 16a of spindle extends entirely through the lock 30 but not into the exterior face of the stile (not shown), because in the illustrated embodiment, there is no corresponding handle on the exterior face to receive and support the end 16a of spindle 16. The two mounting screws for the handle escutcheon extend through the corresponding holes in the stile 10 and the packers 22 and into threaded mounting holes 71, 73, that extend entirely through lock casing 31, and tightening of these mounting screws serves to secure the lock 30 in position.

Key cylinder 18 is secured within its housing 20 with a retainer and wafer screw, and the assembly is then placed through the rectangular shaped opening and lock cylinder locator 23 so as to have cylinder tail 19 extending through rectangular opening in locking cam 54. Key cylinder escutcheon 21 is secured to frame 10 to retain the key cylinder assembly in place and cover the opening.

To further secure the lock 30 within the stile, additional screws (not shown) may be inserted through the side of the stile into the side mounting holes provided near the upper and lower ends of the casing 31. In other embodiments, the lock 30 may be configured as a mortise style lock.

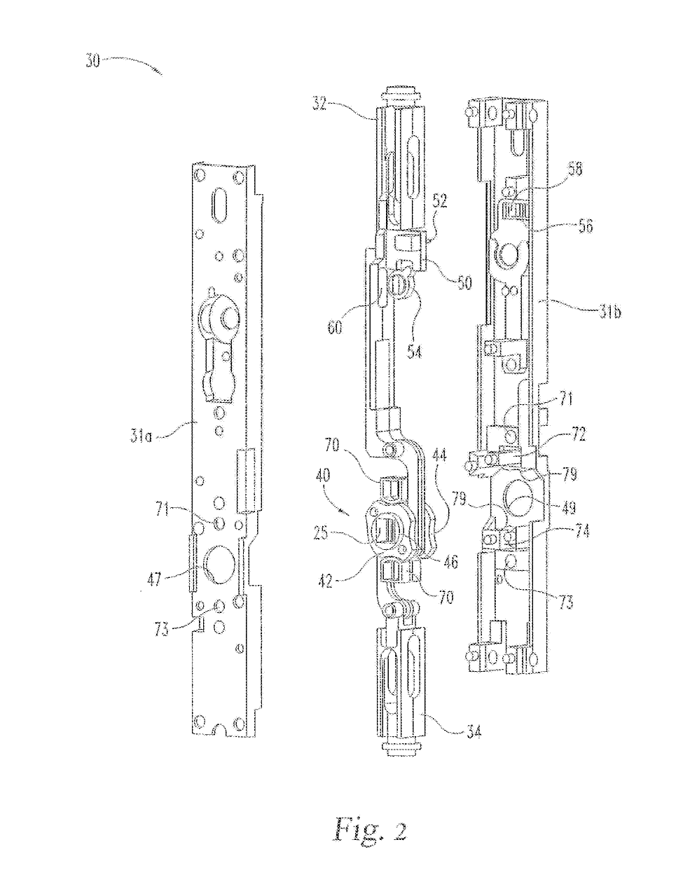

With reference to FIGS. 2-4, spindle 16 extends through the central bore of a shoot bolt driver 40 that is shaped such that it rotates with the spindle 16 in a follower arrangement. The driver 40 is composed of two spindle followers 42 and 44 that are of identical construction and are coupled together by pins 63 and 68, which serve to pivotably connect the assembly to upper and lower linkage arms 62, 66. Follower 42 has a rounder shoulder portion 46 that is rotatable supported in the rounded opening 47 in casing 31a, and the corresponding shoulder portion (not shown) on follower 44 is identically supported in opening 49 of casing 31b. Thus, the driver 40 is supported in the casing 31 at both of its ends, which enhances its stability.

The upper and lower shoot bolt arms 32 and 34 are contained within casing 31 so as to be slidable along the longitudinal axis of lock, which corresponds to the vertical direction. The other end of the upper linkage arm 62 is pivotably coupled to upper shoot bolt arm 32 with pin 64, and the other end of lower linkage arm 66 is pivotably coupled to lower shoot bolt arm 34 with pin 67.

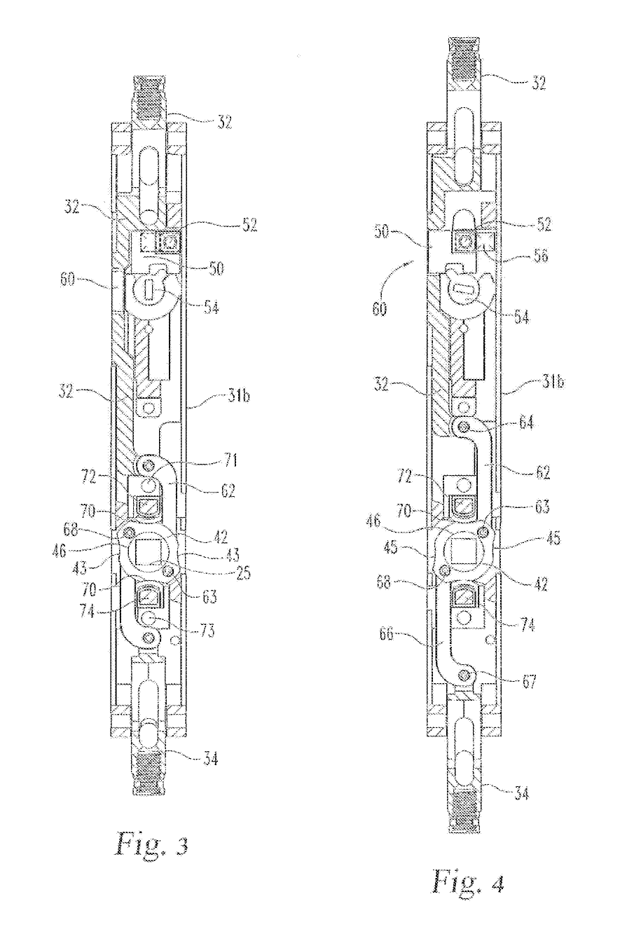

In operation, as the driver 40 rotates counter clockwise as viewed in FIG. 3, which corresponds to the lever handle 14 rotating downward as seen in FIG. 1, the upper shoot bolt arm 32 slides upward and the lower shoot bolt arm 34 slides downward until the mutually extended position of FIG. 4 is reached. Rotation of the handle 14 in the opposite direction reverses the process and moves the shoot bolt arms from the mutually extended position of FIG. 4 to the mutually retracted position of FIG. 3.

In both the mutually extended and mutually retracted configurations, the follower 44 contacts the inwardly projecting lips 79 provided on casing 31b above and below opening 49 (see FIG. 2) and follower 42 contacts corresponding lips (not shown) on casing 31a. The contact of the followers 42, 44 with the casing lips serves as a positive stop to the driver 40 and helps to assure that any additional rotational force applied to the lever is transferred to the casing 31a and 31b, thus protecting the internal lock components.

In the illustrated embodiment, each shoot bolt arm is coupled to an opposing portions of a common driver by way of a single pivoting linkage, which is an efficient design that allows the size of the lock 30 to be reduced. Further, because the shoot bolt arms 32, 34, linkages 62, 66, and driver 40 can be pre assembled as an integrated assembly, overall assembly of the lock 30 can be made more efficient or reliable.

In other embodiments, the shoot bolts arms may be moved in opposite directions by other means know in the art. For example, rather than having both linkages 62, 66 coupled to a common driver 40 so as to move the same extent, one of the spindle hubs 42, 44 can be converted to a planetary gear with one or both of the linkages 62, 66 coupled to a satellite gear. Alternatively, in place of pivotable linkages 62, 66, connecting the shoot bolt arms 32, 34 to the driver 40, the shoot bolt arms can be directly coupled to the driver 40, for example, with a driver pin riding in a slot on the shoot bolt arm.

Locking member 50 is slideable within casing and is constrained to move in a horizontal path as viewed in FIGS. 3 and 4 by a guiding slot (not shown) formed in lock casing 31a and guiding features in the lock casing 31b. The locking member 50 is moved between the unlocked position shown in FIG. 3 and the locked position shown in FIG. 4 by cylinder cam 54, which is actuated by key cylinder 18.

A spring biased plunger 52 is carried within locking member 50 so as to have an operating stroke into the page as viewed in FIGS. 3 and 4. The plunger 52 engages in corresponding recesses 56, 58 in casing 31b and serves to yielding bias the locking member 50 to be in either the locked or unlocked position.

When in the locked position, locking member 50 is received in the longitudinally elongated slot 60 that extends entirely through the upper shoot bolt arm 32. Accordingly, when the locking member 50 is engaged in slot 60 of upper shoot bolt arm 32, retraction of the shoot bolts is prevented. Moreover, if a vandal were to apply a large torque to the handle 14 in an effort to force the lock open, the upper shoot bolt arm 32 can be made to remain locked, and either pin 64 or 63 can be made to break. Thus, while forcing the handle 14 would allow the lower shoot bolt to be withdraw, the upper shoot bolt would remain engage to keep the door secured. Accordingly, the provision of locking member 50 engaging with the upper shoot bolt arm 32 can serve to make the lock more secure against vandals.

In other embodiments, lock 30 may be provided without locking member 50, or locking member 50 may be adapted to directly engage the driver 40.

The outer radial surface of each of the followers 42, 44 are provided with recess 43 and 45 that interact with the curved contacting faces 78 of biasing pads 70 to bias the driver 40 towards stable rest positions. These rest positions correspond to the shoot bolt arms being either fully extended, which is the configuration shown in FIG. 4, or fully retracted, which is the configuration shown in FIG. 3. It is to be understood that a rest position is a position whereby the driver rests against the contact face of the biasing pad 70 in a stable manner (i.e. where the forces applied by the contact face to the driver are balanced so that no moment is created to rotate the driver.) In contrast, when the driver is moved away from a rest position, the contact face of the biasing pad 70 pushes back against the driver 40 so as to create a restoring moment that tends to urge the driver 40 to rotate into one of its stable rest position, though the moment created may or may not be of sufficient magnitude to overcome, for example, the friction related to the shoot bolts entering their respective strikers.

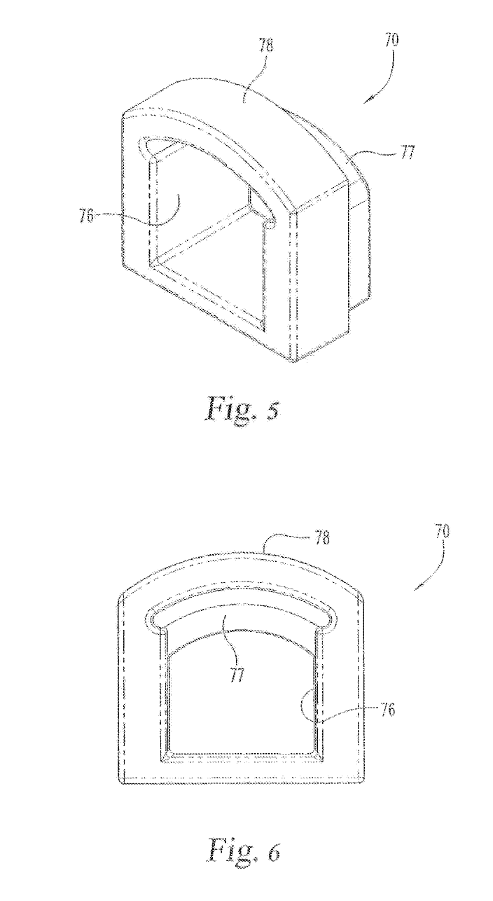

The biasing pads 70 are made of a hard synthetic material, such as nylon, and are secured to mounting posts 72, 74 which extend from lock casing 31b in directions parallel to the axis of the driver 40. More specifically, as shown in FIGS. 5 and 6, each pad 70 has a main body portion or base 77 having a through hole 76 that is shaped like the mounting posts 72 or 74, and each pad 70 has a contacting face 78 that is provided on an arm that is both longitudinally offset from the base 77 and spaced from the base (as viewed in FIG. 6). Two pads 70 are mounted on the upper mounting post 72 and two pads are mounted on the lower mounting post 74 with the bases 77 in each pair adjacent to each other. As a result, the contact faces 78 for one set of the pads 70 are at opposing radial positions relative to follower 42 and the contact faces 78 for another set of the pads 70 are at opposing radial positions relative to with follower 44. The provision of multiple contacting faces 78 interacting with the rotating driver 40 at different points along the axis of the driver 40 and from multiple sides at a single location enhances the stability of lock 30 and serves to reduce the chance that the shoot bolts will be improperly positioned.

In operation, as the driver 40 rotates away from either the home position shown in FIG. 3 or the home position of FIG. 4, the contact face 78 of each pad 70 must compresses or deflect inwardly towards the respective mounting post, which allows for the storage of considerable potential energy in the pad 70, and the release of the stored energy can be sufficient to rotate the driver 40 to one of the home positions.

As is to be appreciated, what has been described includes a novel two point lock for securing bi-fold windows and doors comprising a central lock body, a handle that is rotatable with respect to the lock body between a first rest position and a second rest position, first and second shoot bolt arms that move in opposite directions upon rotation of the handle and are maintained in a mutually retracted position when the handle is in the first rest position and in a mutually extended position when the handle is in the second rest position, a locking member moveable within the casing between a locked position, in which the locking member is engaged with the first shoot bolt arm in its extended position, and an unlocked position, in which the locking member is unengaged with the first shoot bolt arm, and, an actuator, such as would be operated by a key, for moving the locking member between its locked and unlocked positions when the shoot bolt arms are in their mutually extended position. The locking member may be slideable within the housing and yielding biased to remain in at least one of the locked and the unlocked position, which may be accomplished by the provision of at least one spring biased plunger which may operate in a direction normal to the direction of travel of the locking member. The locking member may engage in a locking slot of the first shoot bolt arm, and that slot may correspond in size to the locking member, for example with both being elongated in the direction of travel of the first shoot bolt arm. The locking slot may extend entirely through the first shoot bolt arm.

The motion of the shoot bolt arms may be linked to the rotation of the handle in a number of ways known in the art. In one preferred form, each shoot bolt arm is coupled to a rotating driver by way of a linkage arm that is pivotably coupled to the driver and to the shoot bolt arm. Individual drivers for each arm may be operated from a central hub, or each shoot bolt arm may be coupled to opposing portions of the same rotating driver. The rotating driver may be rotatably supported in the lock body at two different locations along the rotation axis of the driver.

The lock body may include at least one spindle follower that rotates with the handle and at least one biasing device that interacts with the spindle follower to maintain the handle in the first and second rest positions. The biasing device may comprise a plurality of biasing pads having curved contact faces that engage with corresponding recesses in the spindle follower.

What has also been described is a novel two point lock for securing bi-fold windows and doors comprising a central lock body, a driver contained within the body so as to be rotatable by a handle, a plurality of biasing pads having curved contact faces that engage with recess in radial surfaces of the driver to maintain the driver in a first rest position and a second rest position, and first and second shoot bolt arms that move in opposite directions upon rotation of the driver and are maintained in a mutually retracted position when the driver is in the first rest position and in a mutually extended position when the driver is in the second rest position. Each biasing pad may include a body portion and an arm spaced from the body portion. The body portion may be mounted on a post and the arm may be made to deflect towards the post as the driver is rotated between the first rest position and the second rest position. The driver is rotatably supported in the lock body at two different locations along the rotation axis of the driver. The biasing pads may contact the driver at different locations along the rotation axis of the driver and/or at opposing radial positions. The lock may further include a locking member for selectively locking the shoot bolts in their mutually extended position, for example, one that is selectively engageable with the first shoot bolt arm.

What is also described is a two point lock for securing bi-fold windows and doors comprising a central lock body, a driver rotatably supported in the lock body at two different locations along the rotation axis of the driver, at least one biasing pad that interacts with the driver to maintain the driver in a first rest position and a second rest position, and first and second shoot bolt arms that move in opposite directions upon rotation of the driver and are maintained in a mutually retracted position when the driver is in the first rest position and in a mutually extended position when the driver is in the second rest position. The biasing pads may have curved contact faces that engages with recesses in the driver. A plurality of biasing pads contact the driver at different locations along the rotation axis of the driver, and/or at opposing radial positions. The lock body may include a first set of stops which contact the driver in the first position so as to prevent further rotation of the driver in a first direction and/or a second set of stops which contact the driver in the second position so as to prevent further rotation of the driver in a second direction.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A two point lock for bi-fold windows and doors, comprising:
a central lock body comprising a casing;
a handle that is rotatable with respect to the lock body between a first rest position and a second rest position;
first and second shoot bolt arms that move in opposite directions upon rotation of the handle and are maintained in a mutually retracted position when the handle is in the first rest position and in a mutually extended position when the handle is in the second rest position;
a locking member moveable within the casing between a locked position in which the locking member is engaged with the first shoot bolt arm in its extended position, and an unlocked position in which the locking member is unengaged with the first shoot bolt arm; and
an actuator for moving the locking member between its locked and unlocked positions when the shoot bolt arms are in their mutually extended position.

2. The lock of claim 1 wherein the actuator is operated by a key.

3. The lock of claim 1 wherein the locking member is slideable within the casing and yieldingly biased to remain in at least one of the locked position and the unlocked position.

4. The lock of claim 1 wherein the locking member is yieldingly biased to remain in the locked position and the unlocked position by at least one spring biased plunger.

5. The lock of claim 1 wherein the locking member is engaged in a locking slot of the first shoot bolt arm that is elongated in a direction of travel of the first shoot bolt arm.

6. The lock of claim 1 wherein the locking member is engaged in a locking slot of the first shoot bolt arm that extends entirely through the first shoot bolt arm.

7. The lock of claim 1 wherein each shoot bolt arm is coupled to a rotating driver by way of a linkage arm that is pivotably coupled to the driver and to the shoot bolt arm.

8. The lock of claim 7 wherein each shoot bolt arm is coupled to opposing portions of the same rotating driver.

9. The lock of claim 8 wherein the rotating driver is rotatably supported in the lock body at two different locations along the rotation axis of the driver.

10. The lock of claim 1 wherein the lock body includes at least one spindle follower that rotates with the handle and at least one biasing device that interacts with the spindle follower to maintain the handle in the first and second rest positions.

11. The lock of claim 10 wherein the at least one biasing device comprises a plurality of biasing pads having curved contact faces that engage with corresponding recesses in the spindle follower.

12. A two point lock for bi-fold windows and doors, comprising:
a central lock body;
a driver contained within the body so as to be rotatable by a handle;
a plurality of biasing pads having curved contact faces that engage with recess in radial surfaces of the driver to maintain the driver in a first rest position and a second rest position; and
first and second shoot bolt arms that move in opposite directions upon rotation of the driver and are maintained in a mutually retracted position when the driver is in the first rest position and in a mutually extended position when the driver is in the second rest position.

13. The lock of claim 12 wherein each biasing pad comprises a body portion and an arm spaced from the body portion.

14. The lock of claim 13 wherein for each biasing pad the body portion is mounted on a post and the arm deflects towards the post as the driver is rotated between the first rest position and the second rest position.

15. The lock of claim 12 wherein the driver is rotatably supported in the lock body at two different locations along the rotation axis of the driver.

16. The lock of claim 15 wherein the biasing pads contact the driver at different locations along the rotation axis of the driver.

17. The lock of claim 12 wherein the biasing pads contact the driver at opposing radial positions.

18. The lock of claim 12 further comprising a locking member for selectively locking the first and second shoot bolt arms in their mutually extended position.

19. The lock of claim 18 wherein the locking member is selectively engageable with the first shoot bolt arm.

20. A two point lock for bi-fold windows and doors; comprising:
a central lock body;
a driver rotatably supported in the lock body at two different locations along the rotation axis of the driver;
at least one biasing pad that interacts with the driver to maintain the driver in a first rest position and a second rest position; and
first and second shoot bolt arms that move in opposite directions upon rotation of the driver and are maintained in a mutually retracted position when the driver is in the first rest position and in a mutually extended position when the driver is in the second rest position.

21. The lock of claim 20 wherein the at least one biasing pad has a curved contact face that engages with at least one recess in the driver.

22. The lock of claim 20 wherein a plurality of biasing pads contact the driver at different locations along the rotation axis of the driver.

23. The lock of claim 20 wherein a plurality of biasing pads contact the driver at opposing radial positions.

24. The lock of claim 20 wherein the lock body includes a first set of stops which contact the driver in the first position so as to prevent further rotation of the driver in a first direction.

25. The lock of claim 24 wherein the lock body includes a second set of stops which contact the driver in the second position so as to prevent further rotation of the driver in a second direction.

26. (canceled)
